(19) United States
(12) Patent Application Publication
(10) Pub. No.: US 2007/0133110 A1
(43) Pub. Date: Jun. 14, 2007

(54) Voice coil motor type focusing actuator

(75) Inventor: T.C. Huang, Changhua County (TW)

Correspondence Address: BACON & THOMAS, PLLC, 625 SLATERS LANE, FOURTH FLOOR, ALEXANDRIA, VA, 22314, US

(73) Assignee: TRICORE CORPORATION, CHANG HUA (TW)

(21) Appl. No.: 11/634,866

(22) Filed: Dec. 7, 2006

(30) Foreign Application Priority Data
Dec. 9, 2005 (TW) 94221585

(51) Int. Cl. G02B 7/02

(52) U.S. Cl. 359/824

(57) ABSTRACT

A voice coil motor type focusing actuator, which includes a fixed unit formed of a bracket having a rectilinear sliding groove and two magnets mounted in the bracket at two sides, a movable unit formed of a lens holder holding a lens and mounted inside the bracket and slidably coupled with its rectilinear sliding rail to the rectilinear sliding groove of the bracket and two coils respectively mounted on two sides of the lens holder corresponding to the magnets of the fixed unit, and a resilient holding down unit connected between the fixed unit and the movable unit to hold down the movable unit on the inside of the fixed unit.

### BACKGROUND OF THE INVENTION

1. Field of the Invention

The present invention relates to voice coil motor and more particularly, to a voice coil motor type focusing actuator.

2. Description of the Related Art

A conventional voice coil motor type focusing actuator essentially comprises a bracket and a lens holder movably mounted in the bracket. Conventional voice coil motor type focusing actuators have the common drawback of complicated structure, resulting in a complicated installation procedure. Further, improper connection among parts causes instability of the structure. Further, these conventional voice coil motor type focusing actuators cannot prohibit entering of dust and external bodies.

Therefore, it is desirable to provide a voice coil motor type focusing actuator that eliminates the aforesaid drawbacks.

### SUMMARY OF THE INVENTION

The present invention has been accomplished under the circumstances in view. It is one object of the present invention to provide a voice coil motor type focusing actuator, which guides movement of the lens holder thereof smoothly, thereby improving focusing accuracy and lowering the risk of operation failure.

It is another object of the present invention to provide a voice coil motor type focusing actuator, which holds the lens holder in a bracket with resilient holding down members that return the lens holder positively to its former position when power off.

It is still another object of the present invention to provide a voice coil motor type focusing actuator, which uses a dust board to protect the image sensor against dust and external bodies.

To achieve these and other objects of the present invention, the voice coil motor type focusing actuator comprises a fixed unit, the fixed unit comprising a bracket and two magnets mounted in the bracket at two sides, the bracket having a rectilinear sliding groove arranged on an inside wall thereof at two sides; a movable unit, the movable unit comprising a lens holder mounted inside the bracket and two coils respectively mounted on two sides of the lens holder corresponding to the magnets, the lens holder comprising a holder body holding a lens and a rectilinear sliding rail respectively coupled to the rectilinear sliding groove to guide movement of the lens holder relative to the bracket; and a resilient holding down unit connected between the fixed unit and the movable unit to hold down the movable unit on the fixed unit.

### BRIEF DESCRIPTION OF THE DRAWINGS

FIG. 1 is a perspective view of a voice coil motor type focusing actuator according to the present invention.

FIG. 2 is a sectional view taken along line 2-2 of FIG. 1.

FIG. 3 is a sectional view taken along line 3-3 of FIG. 1.

FIG. 4 is an exploded view of the voice coil motor type focusing actuator according to the present invention.

FIG. 5 is an exploded view of a part of the voice coil motor type focusing actuator according to the present invention.

FIG. 6 is a top view of a part of the voice coil motor type focusing actuator according to the present invention.

FIG. 7 is a sectional view taken along line 7-7 of FIG. 6.

FIG. 8 is a sectional view taken along line 8-8 of FIG. 6.

### DETAILED DESCRIPTION OF THE INVENTION

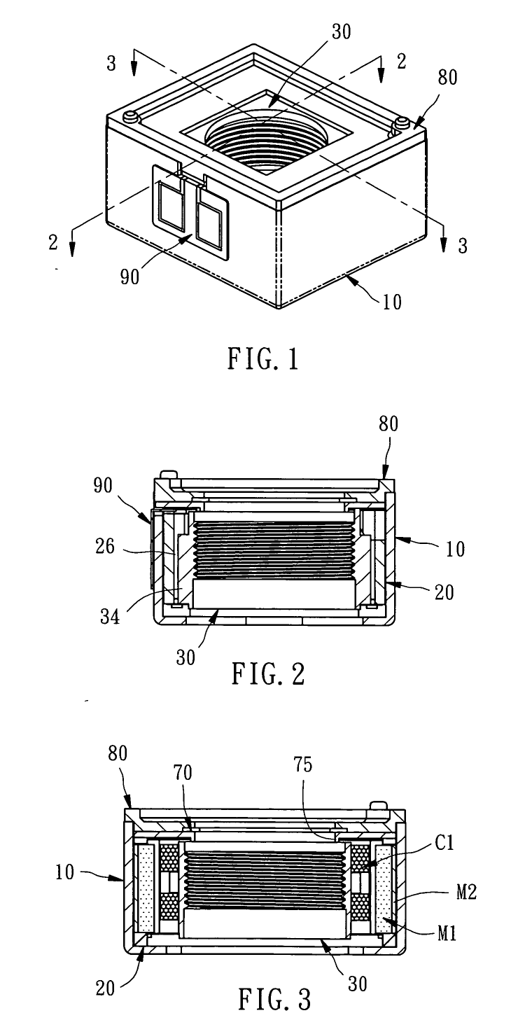

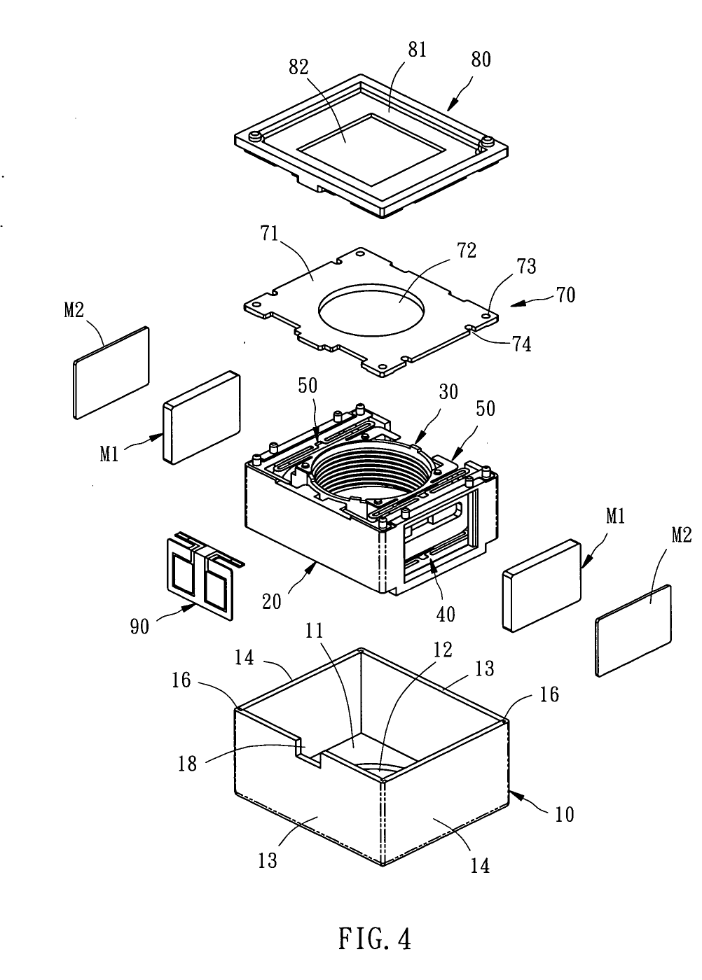

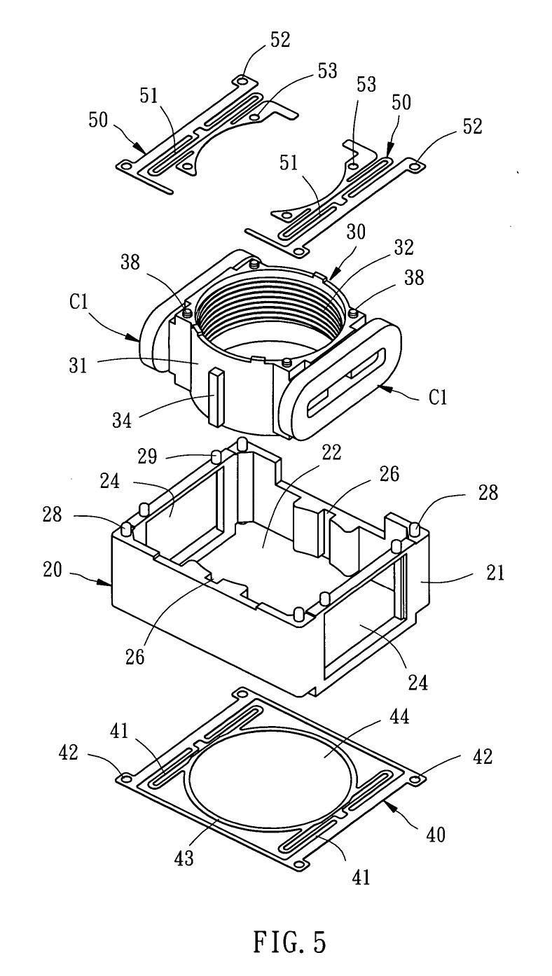

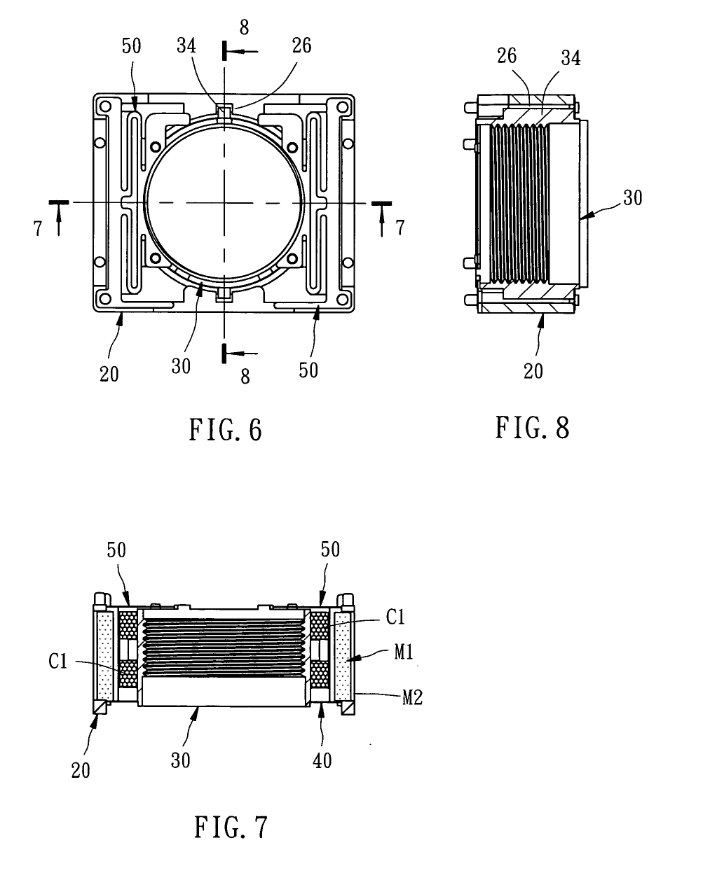

Referring to FIGS. 1˜8, a voice coil motor type focusing in accordance with a first embodiment of the present invention is shown comprising a housing 10, a bracket 20, two magnets M1, a lens holder 30, two coils C1, a first resilient holding down device 40, two second resilient holding down devices 50, a dust board 70, a sensor carrier plate 80, and a terminal 90.

The housing 10 comprises a bottom panel 11, an escape hole 12 cut through the center of the bottom panel 11, two opposite first peripheral panels 13 and two opposite second peripheral panels 14 respectively perpendicularly extending from the four peripheral sides of the bottom panel 11 and fastened one another by a dovetail panel joint 16, and a terminal slot 18 on one first peripheral panel 13.

The bracket 20 comprises a frame body 21 receivable in the housing 10, an accommodation receiving chamber 22 defined in the frame body 21, two magnet mounting portions, for example, magnet mounting holes 24 respectively formed in two opposite sides of the frame body 21 in communication with the accommodation receiving chamber 22, two rectilinear sliding grooves 26 of slide groove respectively formed on the other two opposite sides of the frame body 21 and facing the accommodation receiving chamber 22, eight connecting bolts 28 respectively vertically protruded from the top and bottom sides of the frame body 21, and four locating pins 29 respectively protruded from the frame body 21.

The magnets M1 are respectively mounted in the magnet mounting holes 24 and covered with a respective cover plate M2.

Further, the bracket 20 and the magnets M1 constitute a fixed unit.

The lens holder 30 comprises a holder shell 31 accommodated in the accommodation receiving chamber 22 of the bracket 20, a lens receiving means, for example, a screw hole 32 formed in the holder shell 31 for receiving a lens (not shown), two rectilinear sliding rails 34 of slide rail disposed on the outside wall thereof at two opposite sides and respectively coupled to the rectilinear sliding grooves 26 of the bracket 20, and four connecting bolts 38 protruded from the top side thereof in four corners.

The two coils C1 are respectively mounted on the lens holder 30 at two sides corresponding to the magnets M1 in the magnet mounting holes 24 of the bracket 20.

Further, the lens holder 30 and the coils C1 constitute a movable unit.

The first resilient holding down device 40 comprises two spring members 41 disposed at two sides, four connecting holes 42 respectively fastened to the four connecting bolts 28 at the bottom side of the bracket 20, a bearing portion 43 connected between the spring members 41 and stopped against the bottom side of the holder shell 31 of the lens holder 30, and an escape hole 44 defined in the bearing portion 43 corresponding to the escape hole 12 of the housing 10.

The second resilient holding down devices 50 symmetrical and abutted against each other, each comprising a spring member 51, two outer connecting holes 52 respectively fastened to the connecting bolts 28 at the top side of the bracket 20, two inner connecting holes 53 respectively fastened to the connecting bolts 38 of the lens holder 30, the spring member 51 connected between the part thereof that define the outer connecting holes 52 and the part thereof that define the inner connecting holes 53.

Further, the first resilient holding down device 40 and the second resilient holding down devices 50 constitute a resilient holding down unit.

The dust board 70 comprises a body 71 covered on the top side of the bracket 20 over the second resilient holding down devices 50, an escape hole 72 corresponding to the screw hole 32 of the lens holder 30, four connecting holes 73 respectively fastened to the connecting bolts 28 at the top side of the bracket 20, four locating slots 74 respectively fastened to the locating pins 29 at the top side of the bracket 20, and a dust shield 75.

The sensor carrier plate 80 is covered on the housing 10, comprising a body 81, which holds an image sensor (not shown), and an escape hole 82 on the center corresponding to the escape hole 72 of the dust board 70. Further, the sensor carrier plate 80 and the housing 10 constitute a carrier box.

The terminal 90 is mounted in the terminal slot 18 of the housing 10 and electrically connected to the coils C1.

When electric current is connected to the terminal 90 and the coils C1, the coils C1 are excited to act upon the magnets M1, thereby producing a magnetic force to move the lens holder 30 with the rectilinear sliding rails 34 along the rectilinear sliding rails 26 of the bracket 20.

When electric current is cut off from the terminal 90, the holding down devices 40 and 50 impart a pressure to the lens holder 30 relative to the bracket 20, thereby returning the lens holder 30 to its former position.

Further, the dust shield 75 of the dust board 70 protects the image sensor in the sensor carrier plate 80 against dust and external bodies.

As indicated above, the invention provides a voice coil motor type focusing actuator, which has the following benefits:

1. The lens holder is smoothly movable relative to the bracket, thereby improving the focusing accuracy and lowering the risk of operation failure.

2. The resilient holding down devices support the lens holder on the inside of the bracket stably, and positively return the lens holder when power off.

3. A dust board is provided to effectively protect the image sensor against dust and external bodies.

What is claimed is:

1. A voice coil motor type focusing actuator comprising:
a fixed unit, said fixed unit comprising a bracket and two magnets mounted in said bracket at two sides, said bracket having a rectilinear sliding groove arranged on an inside wall thereof at two sides;
a movable unit, said movable unit comprising a lens holder mounted inside said bracket and two coils respectively mounted on two sides of said lens holder corresponding to said magnets, said lens holder comprising a holder body holding a lens and a rectilinear sliding rail respectively coupled to said rectilinear sliding grooves of said fixed unit to guide movement of said lens holder relative to said bracket; and
a resilient holding down unit connected between said fixed unit and said movable unit to hold down said movable unit on said fixed unit.

2. The voice coil motor type focusing actuator as claimed in claim 1, further comprising a carrier box accommodating said bracket.

3. The voice coil motor type focusing actuator as claimed in claim 2, wherein said carrier box comprises a housing and a sensor carrier plate covered on said housing.

4. The voice coil motor type focusing actuator as claimed in claim 1, wherein said resilient holding down unit comprises a first resilient holding down member mounted on a bottom side of said bracket and stopped against a bottom side of said lens holder, and two second resilient holding down members mounted on a top side of said bracket and stopped against a top side of said lens holder.

5. The voice coil motor type focusing actuator as claimed in claim 1, further comprising a dust board mounted on said bracket and covered on said lens holder.

6. A voice coil motor type focusing actuator comprising:
a fixed unit, said fixed unit comprising a bracket and two magnets affixed to two sides in said bracket;
a movable unit, said movable unit comprising a lens holder mounted inside said bracket and two coils respectively mounted on two sides of said lens holder corresponding to said magnets, said lens holder comprising a lens receiving portion holding a lens;
a resilient holding down unit connected between said fixed unit and said movable unit to hold down said movable unit on said fixed unit; and
a dust board mounted on said bracket, said dust board having a dust shield covered on said lens holder.

7. The voice coil motor type focusing actuator as claimed in claim 6, further comprising a carrier box that accommodates said bracket.

8. The voice coil motor type focusing actuator as claimed in claim 7, wherein said carrier box comprises a housing and a sensor carrier plate covered on said housing.

9. The voice coil motor type focusing actuator as claimed in claim 6, wherein said resilient holding down unit comprises a first resilient holding down member mounted on a bottom side of said bracket and stopped against a bottom side of said lens holder, and two second resilient holding down members mounted on a top side of said bracket and stopped against a top side of said lens holder.
